(19) United States
(12) Patent Application Publication
(10) Pub. No.: US 2002/0167976 A1
(43) Pub. Date: Nov. 14, 2002

(54) Thermally efficient laser head

(76) Inventors: Vernon A. Seguin, Windsor, CT (US); Robert T. Brown, Bolton, CT (US)

Correspondence Address: CANTOR COLBURN, LLP, 55 GRIFFIN ROAD SOUTH, BLOOMFIELD, CT, 06002

(21) Appl. No.: 10/116,570

(22) Filed: Apr. 3, 2002

Related U.S. Application Data
(60) Provisional application No. 60/281,334, filed on Apr. 4, 2001.

(51) Int. Cl. H01S 3/04

(52) U.S. Cl. 372/34

(57) ABSTRACT

A thermally efficient laser head including a laser housing, a heat exchanger disposed so as to be associated with the laser housing, wherein the combination of the laser housing and the heat exchanger includes a structurally neutral axis and a thermal force centroid axis, wherein the centroid axis and the neutral axis are disposed within different planes and a thermal tuning element, wherein the thermal tuning element is disposed relative to the heat exchanger and the laser housing so as to cause the centroid axis and the neutral axis to be disposed within coincidental planes. A laser assembly including a laser head having a longitudinal axis, wherein the laser head includes a laser housing and a heat exchanger, wherein the laser housing is thermally associated with the heat exchanger and a support structure, wherein the support structure is unbendingly associated with the laser assembly so as to allow the laser head to expand along the longitudinal axis. A thermally neutral laser head including a structural neutral axis and a thermally induced force centroid axis, wherein the thermally neutral laser head is designed such that the thermally induced force centroid axis is coincidental with the structural neutral axis. A thermally neutral laser head including a structural neutral axis having a thermal profile and a thermally induced force centroid axis, wherein the thermal profile is tuned such that the thermally induced force centroid axis is coincidental with the structural neutral axis.

### CROSS REFERENCE TO RELATED APPLICATIONS

This application claims the benefit of U.S. Provisional Application No. 60/281,334, filed Apr. 4, 2001, the contents of which are incorporated by reference herein in their entirety.

### FIELD OF THE INVENTION

This invention relates generally to a laser head design and more particularly to a thermal efficient laser head design that reduces and/or eliminates the thermal loading effect.

### BACKGOUND

Historically, certain gas lasers have suffered from problems caused by resonator misalignment as a result of thermal distortion, or bending, of the laser head. Although these devices characteristically employ heat exchangers to remove and/or dissipate heat generated by the laser, temperature differences may still develop between the top and the bottom of the laser head. As such, thermal distortion may occur because a thermal gradient may be established throughout the laser head due to a non-uniform heating of the laser head relative to the heat exchanger used to cool the laser head. Because the end flanges of the laser head contain the mirrors that comprise the optical cavity, bending of the laser head may be detrimental to the operation of the laser and thus may cause poor laser performance (e.g. a drop off in output power, variation or instability in output laser beam pointing direction and/or degradation in beam quality) due to a misalignment of the laser feedback cavity mirrors and/or bending of the ceramic wave-guide structures.

In addition, another and probably more detrimental effect of non-uniform heat distribution between a laser head and a heat exchanger is the tendency for the heat exchanger and laser head to expand and contract laterally at different rates as their temperature increases or decreases. Historically, the heat exchanger and laser head are usually tightly bolted together to obtain good thermal contact for heat transfer and to prevent liquid coolant leaks between the laser head and the heat exchanger. The heat exchanger is in turn bolted onto a stiff and thermally stable optical bench. However, because the heat exchanger and the laser head expands and contracts with temperature, bending of the heat exchanger and the laser head occurs during the expansion/contraction phase causing thermal distortion.

Therefore, a need remains for a laser head that eliminates or minimizes thermal distortion, as described hereinabove, due to a variation in the thermal loading of the laser head.

### BRIEF SUMMARY

A thermally efficient laser head comprising: a laser housing; a heat exchanger disposed so as to be associated with the laser housing, wherein the combination of the laser housing and the heat exchanger includes a structurally neutral axis and a thermal force centroid axis, wherein the centroid axis and the neutral axis are disposed within different planes; and a thermal tuning element, wherein the thermal tuning element is disposed relative to the heat exchanger and the laser housing so as to cause the centroid axis and the neutral axis to be disposed within coincidental planes.

A laser assembly comprising: a laser head having a longitudinal axis, wherein the laser head includes a laser housing and a heat exchanger, wherein the laser housing is thermally associated with the heat exchanger; and a support structure, wherein the support structure is unbendingly associated with the laser assembly so as to allow the laser head to expand along the longitudinal axis.

A thermally neutral structure comprising: a structural neutral axis; and a thermally induced force centroid axis, wherein the thermally neutral structure is designed such that the thermally induced force centroid axis is coincidental with the structural neutral axis.

A thermally neutral structure comprising: a structural neutral axis having a thermal profile; and a thermally induced force centroid axis, wherein the thermal profile is tuned such that the thermally induced force centroid axis is coincidental with the structural neutral axis.

A structural assembly comprising: a support bench; and a structure having a longitudinal axis, wherein the structure is expandingly associated with the support bench so as to allow the structure to expand and contract along the longitudinal axis.

### BRIEF DESCRIPTION OF THE DRAWINGS

Referring now to the exemplary drawings, wherein like elements are numbered alike in the several figures in which:

FIG. 1 is a cross sectional view of a laser head of a CO₂ laser;

FIG. 2 is a diagram of the beam bending expansion and restoring forces acting upon the laser head of a CO₂ laser;

FIG. 3 illustrates thermal distortion/bending of the laser head of a CO₂ laser;

FIG. 4 is a side view of a CO₂ laser showing the laser housing structure;

FIG. 5 is a schematic diagram of a laser system for material processing;

FIG. 6 is an isometric view showing the laser head of a CO₂ laser;

FIG. 7 is a top down cross-sectional view of a first mirror holder assembly for the laser head of a CO₂ laser showing a Thin Film Polarizer (TFP);

FIG. 8 is an end view of a first mirror holder assembly for the laser head of a CO₂ laser;

FIG. 9A is a top down view of the laser head of a CO₂ laser;

FIG. 9B is a side view of the laser head of a CO₂ laser;

FIG. 9C is a bottom view of the laser head of a CO₂ laser;

FIG. 9D is an end view of a first mirror holder assembly for the laser head of a CO₂ laser;

FIG. 9E is an end view of a second mirror holder assembly for the laser head of a CO₂ laser;

FIG. 10A is a cross-sectional end view of the laser head of a CO₂ laser, in accordance with a first embodiment;

FIG. 10B is a side view of an insulating insert, in accordance with a first embodiment;

FIG. 10C is a top view of an insulating insert, in accordance with a first embodiment;

FIG. 11A is a top down view of a first mirror holder assembly for the laser head of a CO₂ laser, in accordance with an exemplary embodiment;

FIG. 11B is a top down view of a second mirror holder assembly for the laser head of a CO₂ laser, in accordance with an exemplary embodiment;

FIG. 12A is a bottom view of a heat exchanger for the laser head of a CO₂ laser, in accordance with a second embodiment;

FIG. 12B is a side view of a heat exchanger for the laser head of a CO₂ laser, in accordance with a second embodiment;

FIG. 13A is a side view of a CO₂ laser assembly showing a heat exchanger, a laser head and an optical bench, in accordance with a third embodiment;

FIG. 13B is a top down view of a CO₂ laser assembly showing a heat exchanger, a laser head and an optical bench, in accordance with a third embodiment;

FIG. 14 is a first isometric view of the laser housing for a CO₂ laser;

FIG. 15 is a second isometric view of the laser housing for a CO₂ laser; and

FIG. 16 is an isometric view of the laser housing for a CO₂ laser without a cover.

### DETAILED DESCRIPTION OF AN EXEMPLARY EMBODIMENT

One novel approach to eliminating or reducing thermal distortion of a laser head due to variation in the thermal loading of the laser head is to reduce the temperature difference between the heat exchanger and the top surface of the laser head. This reduction in thermal gradient acts to reduce the thermal loading on the laser head by “shifting” the thermally induced force centroid so that it passes through the neutral axis of the laser structure. In accordance with a first embodiment, this may preferably be accomplished by selectively removing material from the heat exchanger or from the laser housing (e.g. milling appropriately designed grooves into the structure). In accordance with a second embodiment, this may also preferably be accomplished by employing a thermal insulation material between the coolant passages and the heat exchanger.

In accordance with a third embodiment, for laser designs that utilize a separate optical bench, a related novel approach to eliminating or reducing thermal distortion of a laser head due to variation in the thermal loading of the laser head is to use the optical bench to provide stiffness to the laser structure. This approach advantageously allows the laser housing/heat exchanger to expand axially while preventing the laser housing/heat exchanger from bending or bowing. Each of the embodiments described hereinabove are discussed below.

An exemplary embodiment is described herein by way of illustration as may be applied to the laser head of a gas laser and more specifically to the laser head of a CO₂ laser. While an exemplary embodiment is shown and described hereinbelow, it will be appreciated by those skilled in the art that the invention is not limited to the embodiment and application described herein, but also to any lasing device which employs a laser head or other component that is susceptible to thermal distortion. Those skilled in the art will appreciate that a variety of potential implementations and configurations are possible within the scope of the disclosed embodiments.

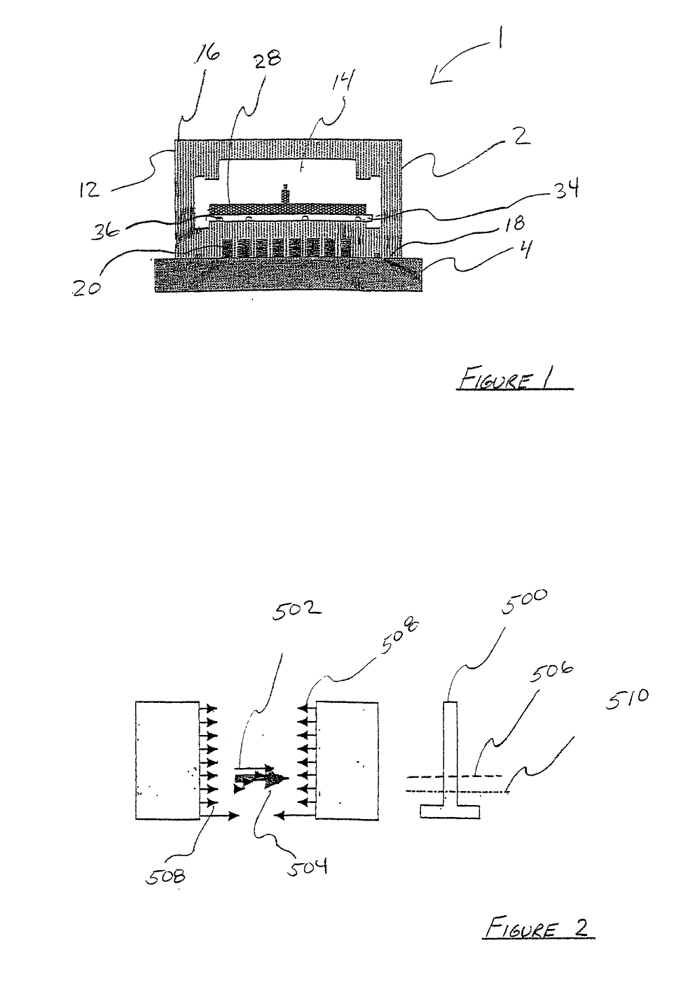

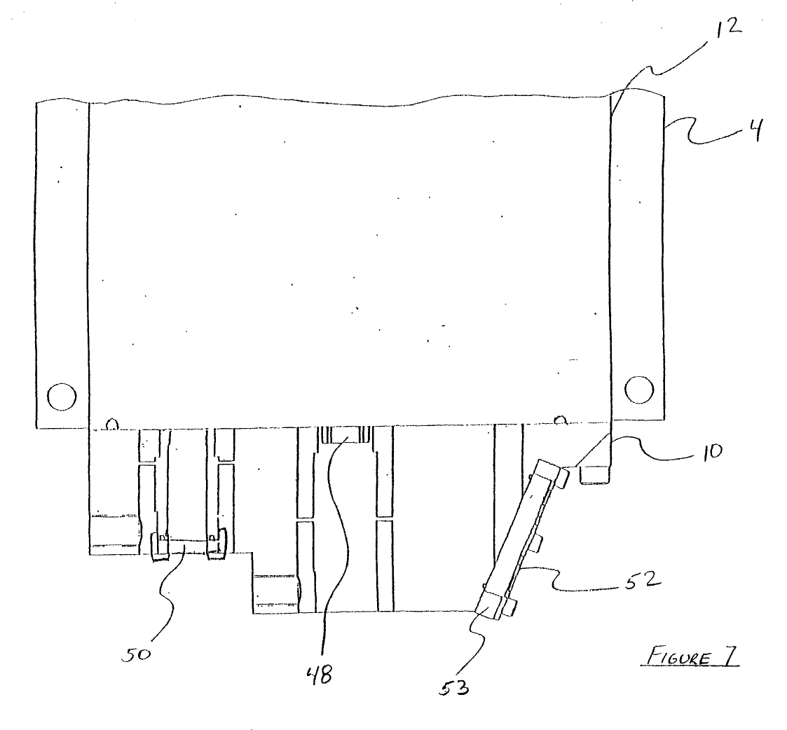

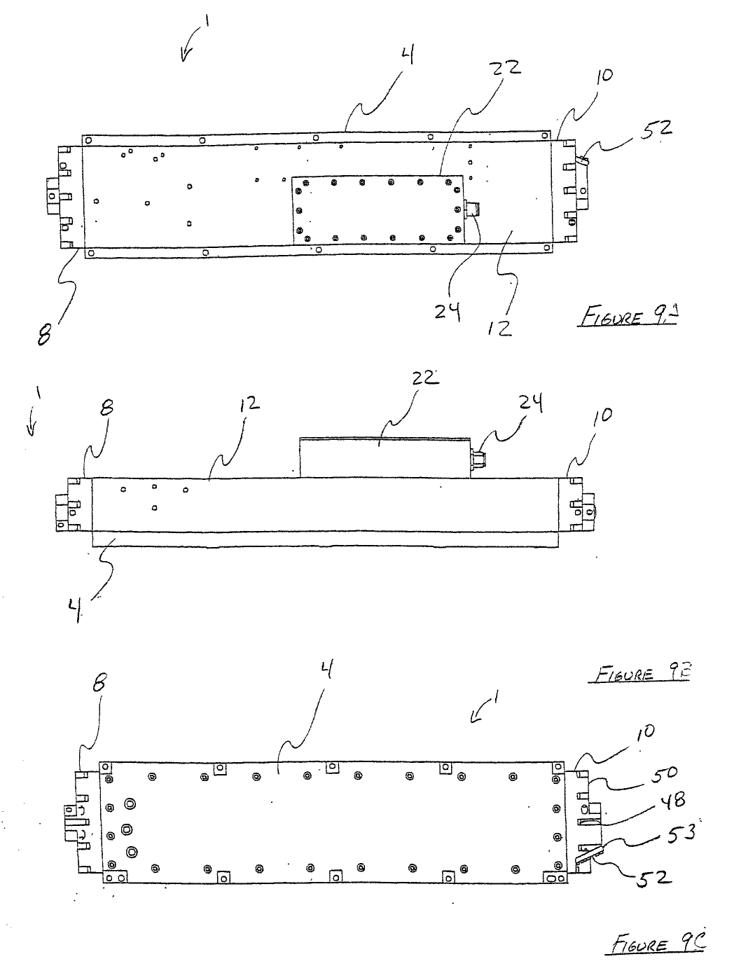

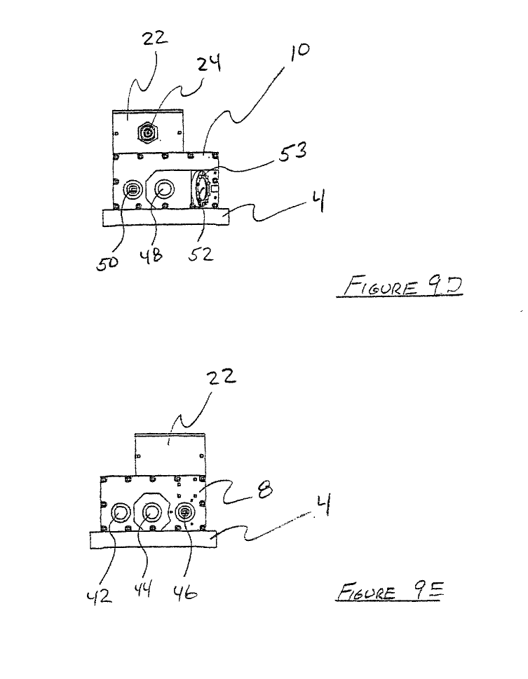

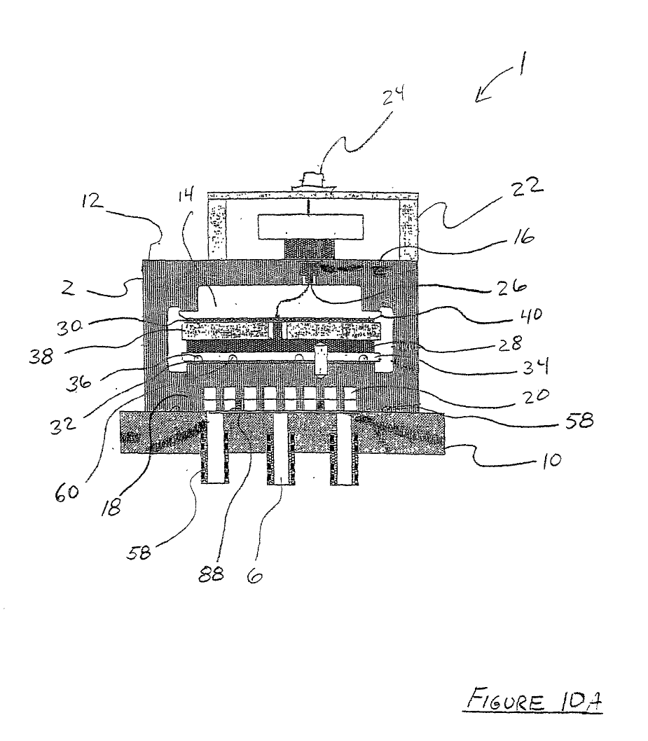

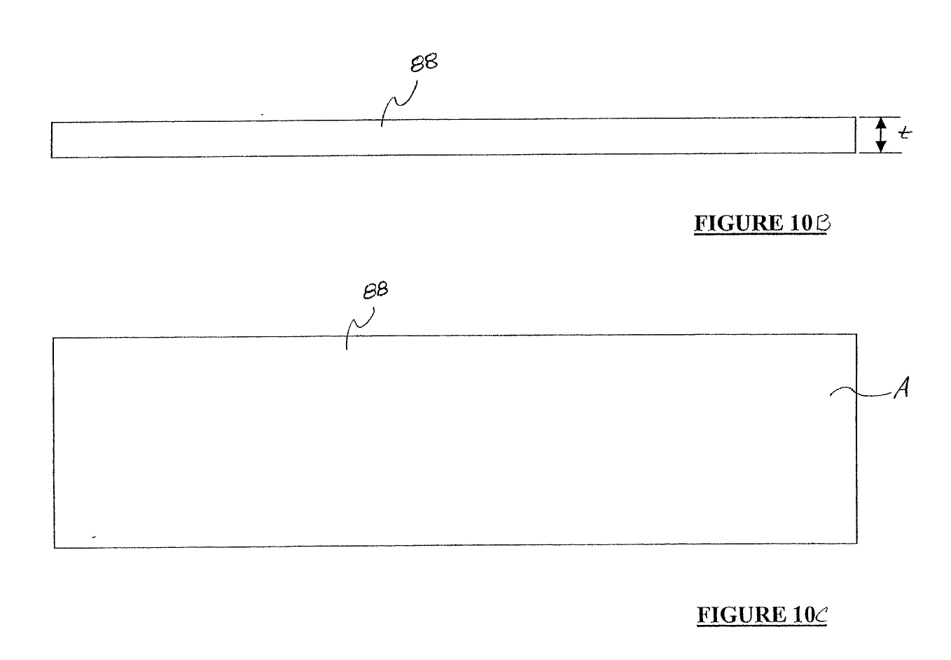

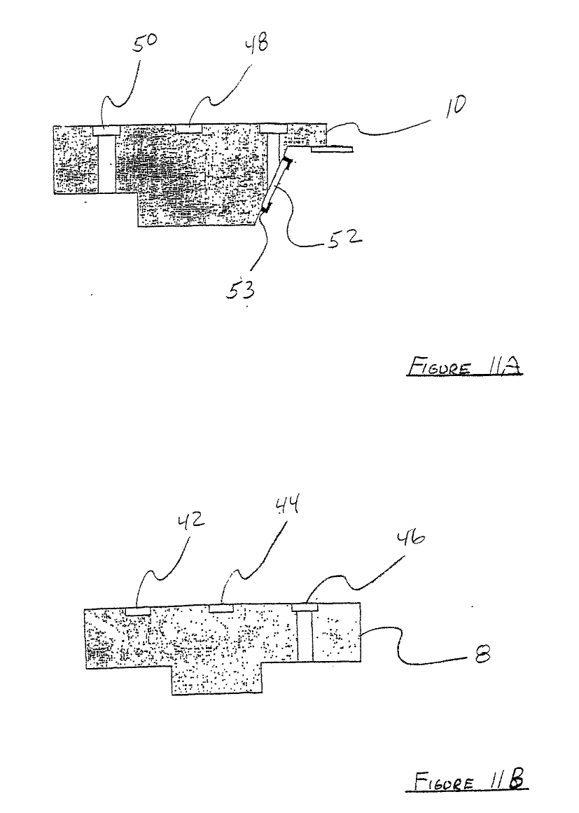

Referring to FIGS. 1, 4, 6, 9A, 9B, 9C, 10A, 13A, 13B, 14, 15 and 16 a laser assembly 1 having a hermetically sealed folded beam forming the laser cavity, either in a folded free space form or in a folded wave-guide form, electro-optically Q-switched CO₂ laser head 2 is shown and discussed. It is understood that laser assembly 1 may well be a continuous wave (CW), a pulsed, a simultaneously Q-switched and cavity dumped and/or a mode locked operated laser assembly. Laser head 2 includes a heat exchanger 4 having an exchanger coolant channel 6, a first mirror assembly 8, a second mirror assembly 10 and a laser housing 12, wherein laser housing 12 defines a gas containing housing cavity 14 and includes a housing top 16 and a housing bottom 18 having a housing coolant channel 20. First mirror assembly 8 and second mirror assembly 10 are disposed relative to laser housing 12 so as to enclose and hermetically seal housing cavity 14. Heat exchanger 4 is disposed relative to housing bottom 18 so as to communicate exchanger coolant channel 6 with housing coolant channel 20.

Heat exchanger 4 includes a coolant inlet 54 and a coolant outlet 56 disposed so as to be communicated with exchanger coolant channel 6. Laser assembly 1 includes an O-Ring 58 associated with exchanger coolant channel 6 and/or housing coolant channel 20 so as to prevent coolant leaks from laser assembly 1. Heat exchanger 4 is disposed so as to be associated with housing bottom 18 such that exchanger coolant channel 6 is communicated with housing coolant channel 20 and so as to form a seal between housing coolant channel 20 and exchanger coolant channel 6.

Laser head 2 also includes an RF matching network 22 having an RF input 24 and an RF output 26, an upper electrode 28, distributed tuning inductors 30, a lower electrode 32 and a ceramic wave-guide 34 having a folded optical multiple wave-guide channel 36. It is understood that a free space folded arrangement, instead of the wave-guide arrangement, may also be utilized as well known in the state of the art. RF matching network 22 is disposed relative to laser housing 12 such that RF output 26 is communicated with housing cavity 14 via a hermetically sealed interface. In addition, although RF input 24 is preferably a BNC type connector, RF input 24 may be any type of RF connector suitable to the desired end purpose.

Distributed tuning inductors 30 are disposed so as to be communicated with RF output 26 and upper electrode 28, wherein tuning inductors 30 are separated from upper electrode 28 via an insulating plate 38. Ceramic wave-guide 34 is disposed so as to be communicated with upper electrode 28 and lower electrode 32, wherein lower electrode 32 is disposed so as to be associated with optical wave-guide channel 36 and housing bottom 18. Moreover, tuning inductors 30 are further communicated with laser housing 12 via support springs 40 so as to provide a low inductance, low resistance path to ground (e.g. laser housing 12) and so as to hold upper electrode 28, ceramic wave-guide 34 and lower electrode 32 together. Furthermore, ceramic wave-guide 34 is disposed so as to communicate optical wave-guide channel 36 with first mirror assembly 8 and second mirror assembly 10. Laser head 2 is essentially the same as disclosed in U.S. patent application Ser. No. 09/039,036 entitled RF Excited Waveguide Laser. Ceramic wave-guide 34 is preferably a five-pass zigzag folded wave-guide, however ceramic wave-guide 34 may have any folded wave-guide configuration suitable to the desired end purpose, such as a three-pass or more than five-pass folded wave-guide configuration. The folded laser beam within the cavity can also be of a free space nature instead of wave-guides.

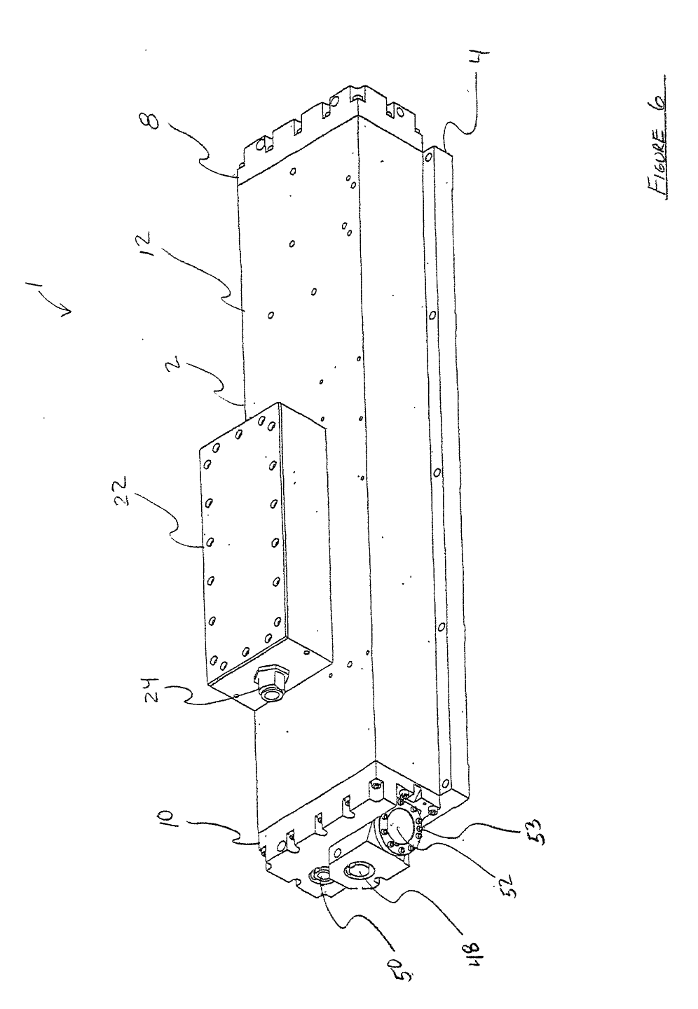

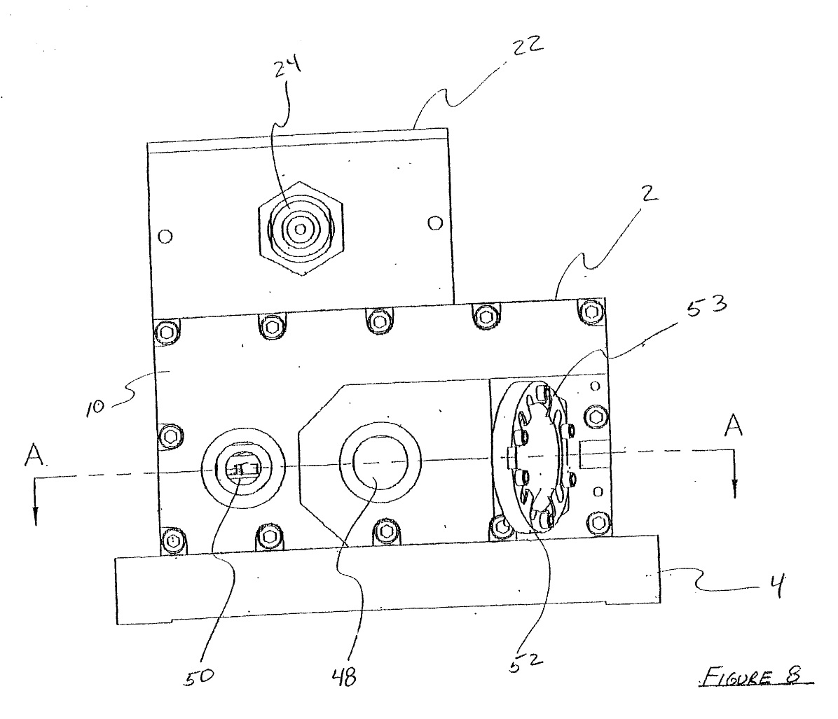

Referring to FIGS. 5, 6, 7, 8, 9D, 9E, 11A, and 11B first mirror assembly 8 includes a first turning mirror (TM₁) 42, a third turning mirror (TM₃) 44 and an output coupling mirror (OCM) 46. Second mirror assembly 10 includes a second turning mirror (TM₂) 48, a fourth turning mirror (TM₄) 50 and a first thin film polarizer (TFP₁) 52. TM₁, 42 is disposed so as to be in optical communication with TFP₁ 52 and TM₂ 48 via optical wave-guide channel 36. TM₃ 44 is disposed so as to be in optical communication with TM₂ 48 and TM₄ 50 via optical wave-guide channel 36. Moreover, TM₄ 50 is disposed so as to be in optical communication with OCM 46 via optical wave-guide channel 36.

TFP₁ 52 is associated with laser head 2 via a TFP₁ holder 53 so as to form a hermetical seal between TFP₁ holder 53 and laser head 2. Laser assembly 1 further includes a second thin film polarizer (TFP₂) 55 disposed so as to be optically communicated with OCM 46. There is an option to place a window in place of TFP₁ 52 and then place TFP₁ 52 external to laser head 2. In this case TFP₁ 52 may be placed either to the right or left of the laser head output. Laser head 2 also includes a feed back mirror 200, an Electro-Optic Modulator 202, a phase retarding device 204, a pulse signal generating system 206 and control circuitry 208.

Laser head 2 further includes a metal O-ring (Not Shown) sealingly associated with OCM 46 and TM₄ 50 so as to form and maintain a hermetical seal as disclosed in U.S. patent application Ser. No. 09/612,733 entitled “High Power Waveguide Laser,” filed on Jul. 10, 2000 and in U.S. Provisional Patent Application Serial No. 60/041,092 entitled “RF Excited Waveguide Laser,” filed on Mar. 14, 1997 and ultimately issuing as U.S. Pat. No. 6,192,061 all of which are incorporated herein by reference. The mirror holder assembly for OCM 46 and TM₄ 50, which transmit radiation out of laser head 2, and TM₁ 42, TM₂ 48 and TM₃ 44, which do not transmit radiation out of laser head 2, are as disclosed in U.S. Provisional Patent Application Serial No.60/041,092.

RF power is applied to RF matching network 22 via RF input 24. This RF power is then communicated to tuning inductors 30 via RF output 26 that then applies the RF power to upper electrode 28. Upper electrode 28 then provides the RF power to optical wave-guide channel 36, and hence to a laser gas 60 disposed within optical wave-guide channel 36, via ceramic wave-guide 34. Laser gas 60 is communicated with lower electrode 32 so as to complete the circuit and cause a laser gas discharge within optical wave-guide channel 36. Although lower electrode 32 is preferably a low particulate generating TiO₂ electrode, lower electrode 32 may be any electrode suitable to the desired end purpose.

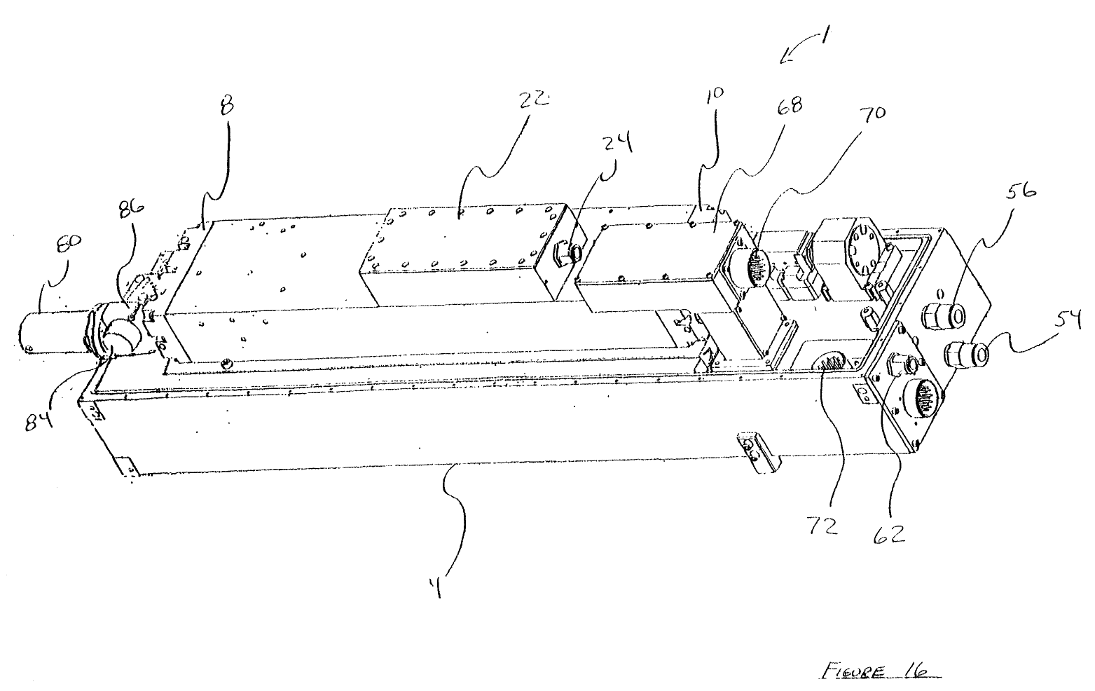

Referring to FIGS. 15 and 16, a view of laser assembly 1 is shown without a cover showing laser head 2, RF matching network 22, first mirror assembly 8 and second mirror assembly 10. RF input 24 is communicated with a laser assembly RF connector 62 conveniently disposed on the laser assembly 1. In addition, an electro-optical modulator 64 and a reflective mirror assembly 66 containing both a reflective mirror and a reflective polarization rotator (RPR) is also shown combined into one housing so as to simplify the optical alignment of optical wave-guide channel 36. A wiring harness (not shown) and an Automatic Down Delay Circuit (ADDC) assembly detector 68 having an ADDC output connector 70 is provided wherein ADDC output connector 70 is communicated with a matching connector 72 via the wiring harness within laser assembly 1.

In addition, laser assembly I includes an interface board connector 74 and a manual optical attenuator assembly 76, wherein manual optical attenuator assembly 76 includes two thin film polarizers (not shown). In addition, laser assembly 1 also includes an optional manual variable resistor potentiometer (not shown), which can be used to vary the voltage applied to an EO modulator 78 that is used to vary the output power of the Q-switched laser. If an optional manual variable resistor potentiometer is used it may be located to the right of an optional optical attenuator assembly 80. This manual variable resistor potentiometer may be replaced by circuitry that will enable the use of an electric signal to vary the voltage if non-mechanical control is desired. The output power of the Q-switched laser may be varied by any circuitry, device and/or method suitable to the desired end purpose.

Moreover, a laser beam dump assembly 82 and an optical shutter 84 having a driving solenoid 86 is also provided. When optical shutter 84 is activated via driving solenoid 86, laser beam dump assembly 82 absorbs and dissipates the energy from the laser beam so as to prevent the laser beam from exiting laser assembly 1. In addition, laser assembly 1 may include a support structure wherein the support structure is an optical bench 100 having high voltage circuitry (not shown) contained within a high voltage circuitry compartment 132 of optical bench 100. High voltage circuitry compartment 132 is well shielded electrically so as to prevent story RF radiation from escaping.

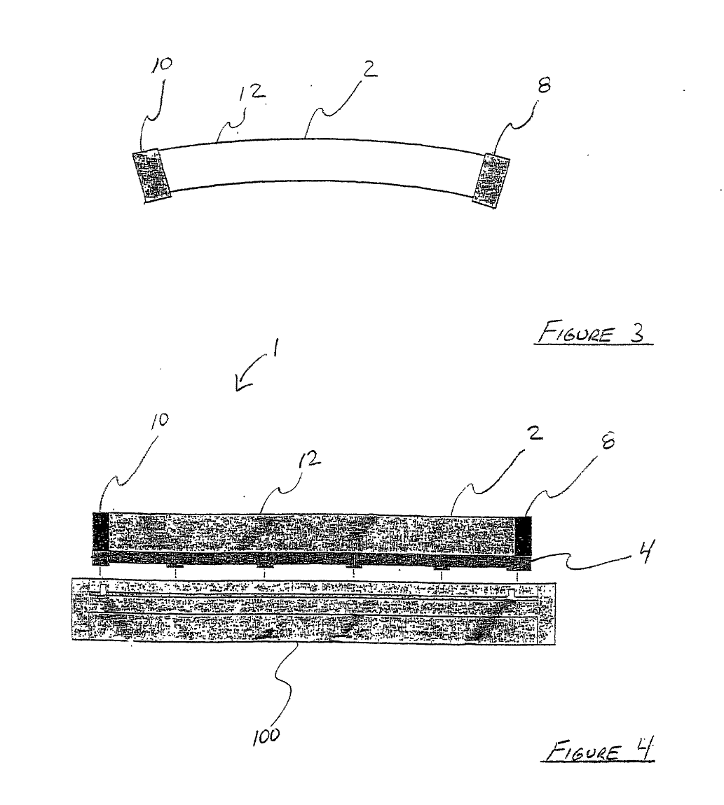

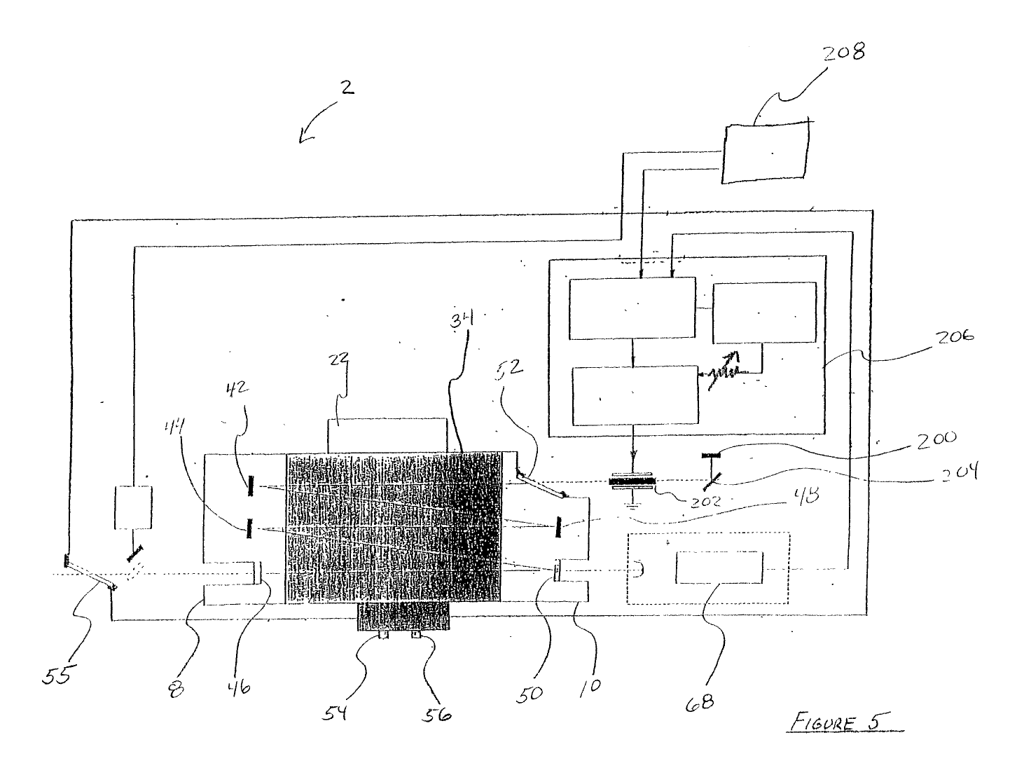

Referring to FIG. 2 and FIG. 3, a mechanical beam cross section representative of laser head 2 is depicted as an inverted tee 500 and shows expansion forces 502 representative of those corresponding to the thermal gradient in laser head 2. Expansion forces 502 are proportional to the metal temperature of laser head 2 and are caused by the tendency of the metal to expand with increasing temperature. For the purpose of estimating the mechanical bending of laser head 2, expansion forces 502 can be replaced by a single force 504 passing through the centroid axis 506 of the distribution of expansion forces 502. These expansion forces 502 are counteracted by restoring forces 508, which are proportional to the mechanical beam cross sectional area of laser head 2, wherein the moment of these restoring forces 508 around the neutral axis 510 of the mechanical beam is zero. Therefore, if the centroid axis 506 is above neutral axis 510, laser head 2 will tend to bow with the ends bending downward.

Referring to FIGS. 2, 3, 10A, 10B and 10C, a first embodiment of laser assembly 1 is shown and discussed. In accordance with a first embodiment, laser assembly 1 preferably includes a thermal tuning element, such as an insulating insert 88 disposed so as to separate heat exchanger 4 from housing coolant channel 20 contained within housing bottom 18. This advantageously reduces the temperature difference between the heat exchanger 4 and a coolant contained within the housing coolant channel 20, causing the heat exchanger 4 to run hotter than normal due to thermal conduction down the side of laser housing 12. This advantageously insures that the temperature of heat exchanger 4 is higher than that of the coolant and thus reduces and/or eliminates unwanted bending of laser head 2 by effectively shifting the centroid axis 506 down toward the neutral axis 510 of laser head 2 so as to lie within the same or coincidental plane. Insulating insert 88 preferably includes a prescribed thickness, t, and/or area, A, and provides a predetermined amount of thermal insulation responsive to the thickness, t, and/or area, A. Therefore, in accordance with a first embodiment, thickness, t, and/or area, A should be selected so as to provide a predetermined amount of thermal insulation. In addition, insulating insert 88 is preferably constructed of Teflon®. However, insulating insert 88 may be constructed of any insulating material suitable to the desired end purpose.

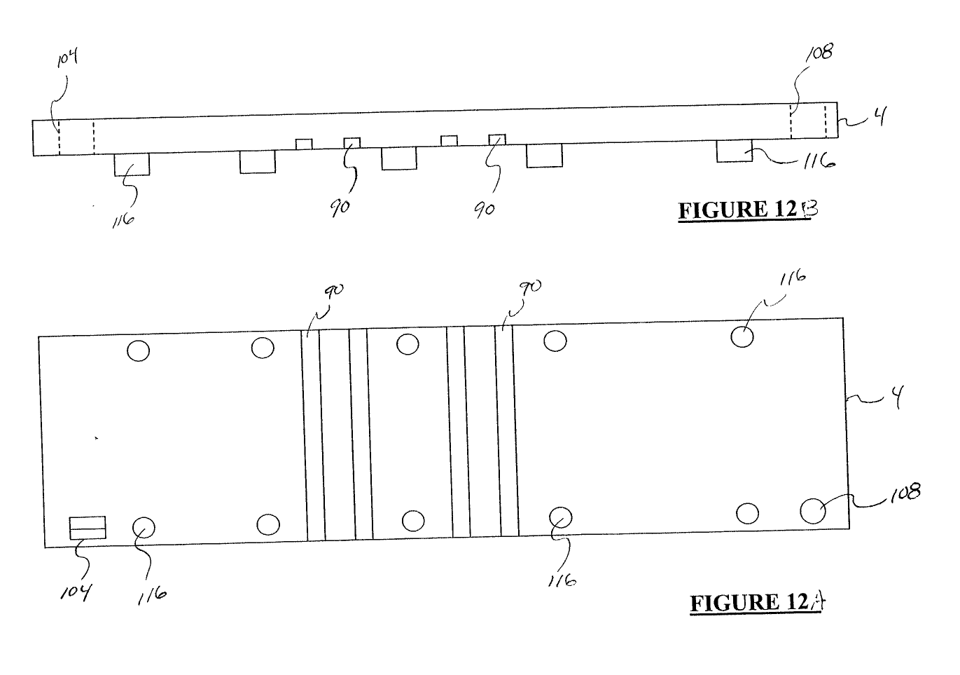

Referring to FIGS. 2, 3, 12A and 12B, a second embodiment of laser assembly 1 is shown and discussed. In accordance with a second embodiment, heat exchanger 4 preferably includes a thermal tuning element such as a plurality of tuning slots 90 disposed on the bottom of heat exchanger 4. Because heat exchanger 4 is non-movably and rigidly associated with laser housing 12, heat exchanger 4 forms part of the mechanical structure of laser assembly 1. As such, neutral axis 510 of laser housing 12 and heat exchanger 4 combination may be shifted or moved by selectively removing material from heat exchanger 4 and/or laser housing 12. In accordance with a second embodiment, plurality of tuning slots 90 preferably aligns the centroid axis 506, caused by thermal differences between heat exchanger 4 and laser housing 12, with the neutral axis 510 of the laser housing 12 and heat exchanger 4 combination. This advantageously shifts the bending forces on centroid axis 506 to neutral axis 510 of the laser housing 12 and heat exchanger 4 combination so as to cause centroid axis 506 and neutral axis 510 to lie within the same or coincidental plane and thus so as to eliminate and/or reduce the effect of bending forces caused by thermal gradients and thus advantageously reduces the bending of laser head 2 by unstiffening heat exchanger 4 so that heat exchanger 4 is not able to bend laser head 2.

In accordance with a second embodiment, the amount of material to be removed from heat exchanger 4 and/or laser housing 12 is preferably determined via computer code calculations (e.g. finite-element calculations) and/or by empirical trial-and-error experimentation. However, the amount of material to be removed from heat exchanger 4 and/or laser housing 12 may be determined using any device and/or method suitable to the desired end purpose. In addition, the optimum geometry of heat exchanger 4 and/or laser housing 12 is preferably determined via computer code calculations (e.g. finite-element calculations) and/or by empirical trial-and-error experimentation. However, the optimum geometry of heat exchanger 4 and/or laser housing 12 may be determined using any device and/or method suitable to the desired end purpose.

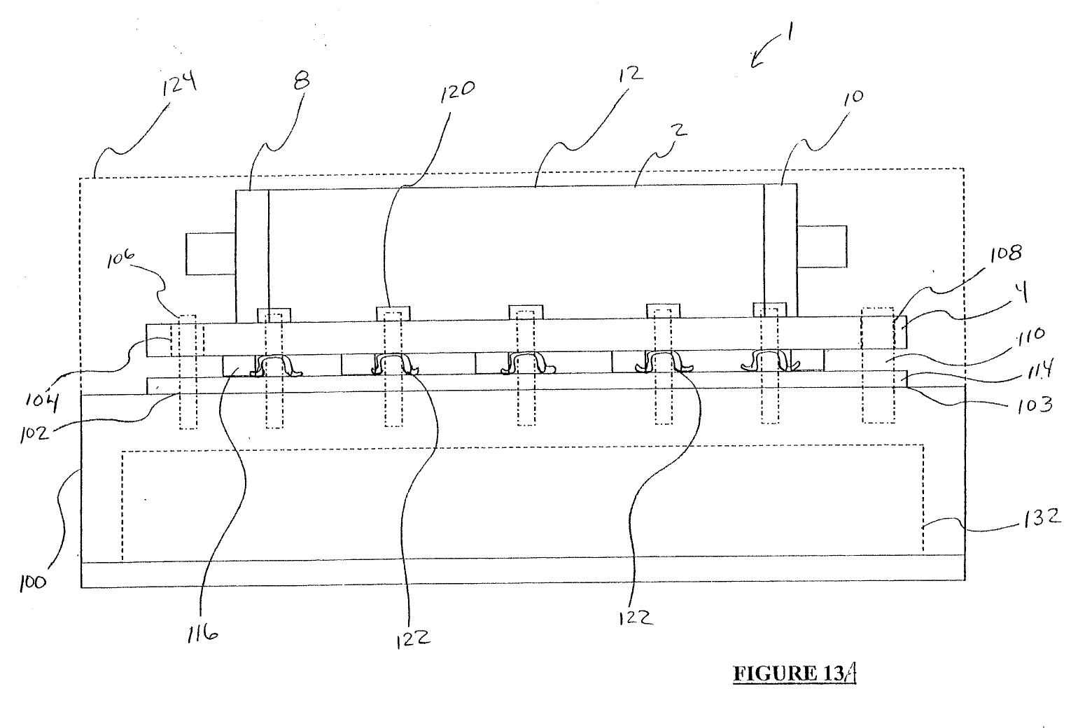

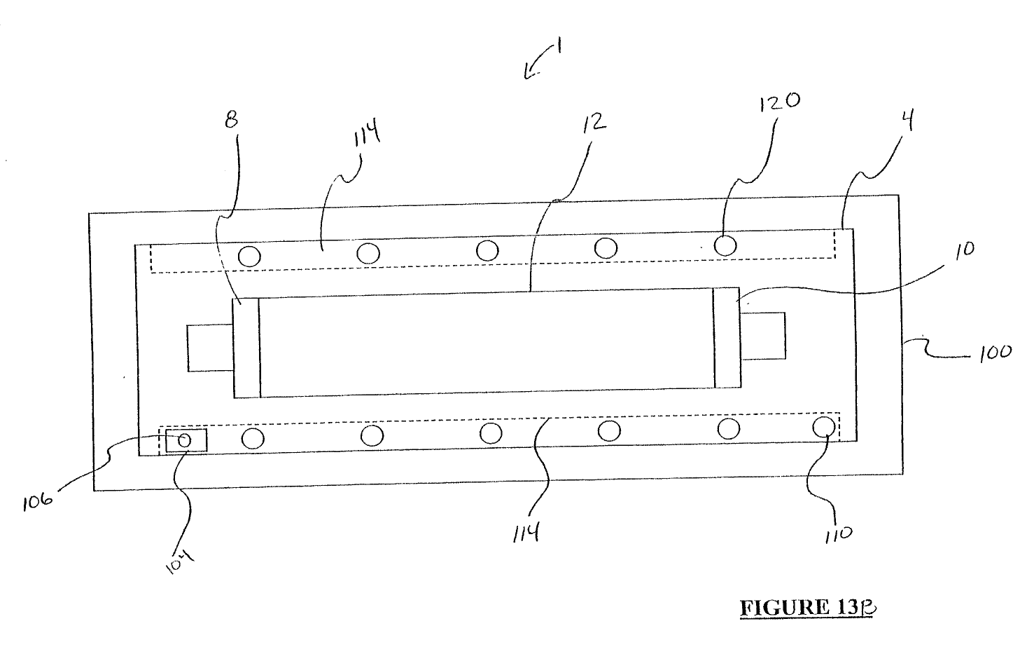

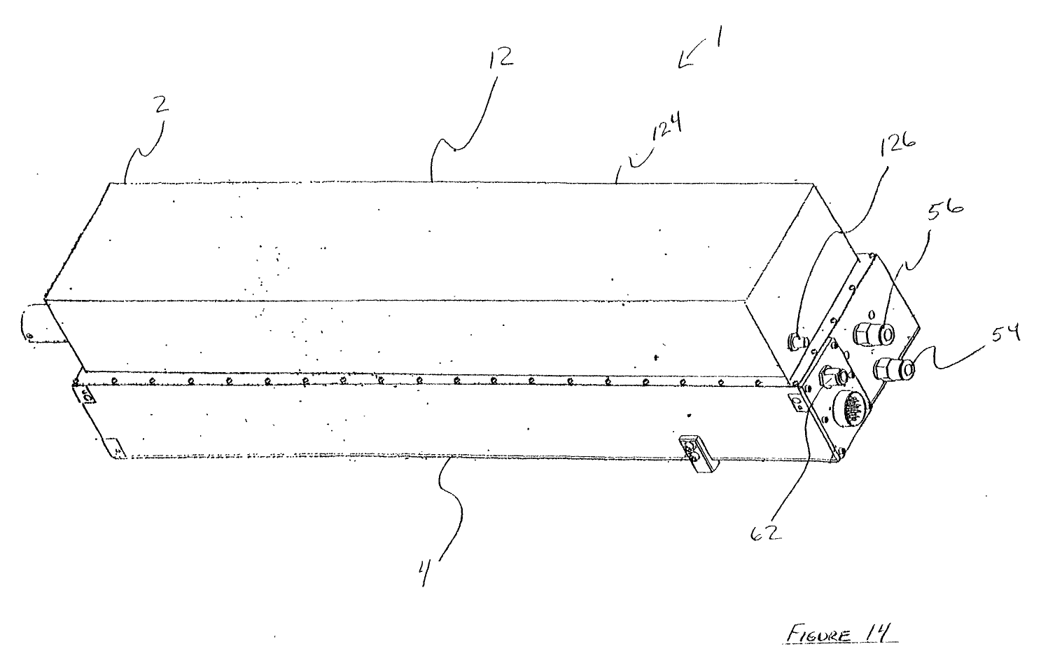

Referring to FIG. 4, 12A, 12B, 13A and FIG. 13B, a third embodiment of laser assembly 1 having optical bench 100 is shown and discussed. In accordance with a third embodiment, laser assembly 1 preferably further includes optical bench 100 having a bench slot 102 and a mounting slot 103. Heat exchanger 4 includes a short slot 104 and a fitted pin 106, wherein heat exchanger 4 is preferably disposed upon optical bench 100 so as to communicate short slot 104 with bench slot 102. Fitted pin 106 is associated with bench slot 102 via short slot 104 so as to protrude through the bottom of heat exchanger 4 and into bench slot 102 in a tightly fitted manner. In accordance with a third embodiment, short slot 104 includes a slot length l and a slot width w, wherein slot width w is preferably sized so as to prevent fitted pin 106 from moving in the direction of the slot width w. In addition, slot length l is preferably sized so as to allow heat exchanger 4 to move in the direction of the slot length l relative to fitted pin 106. This advantageously allows heat exchanger 4 to slide back and forth with respect to optical bench 100 and laser head 2, but not from side to side. In accordance with a third embodiment, optical bench 100 is preferably a mechanically rigid, stiff and thermally stable structure.

In accordance with a third embodiment, heat exchanger 4 also includes a fastening slot 108 and a fastening pin 110, wherein heat exchanger 4 is preferably disposed upon optical bench 100 so as to communicate fastening slot 108 with mounting slot 103. Fastening pin 110 is associated with mounting slot 103 via fastening slot 108 so as to protrude through the bottom of heat exchanger 4 and into mounting slot 103 in a tightly fitted manner. This pins the heat exchanger 4 to a fixed location at one end of optical bench 100 and allows the other end of heat exchanger 4 to expand and contract longitudinally along the longitudinal axis of laser head 2 with respect to the optical bench 100. Since the laser structure is much longer than it is wide, transverse expansion does not contribute greatly to the optical alignment problem. Ball bearings riding in a V-groove slot is another alternative to the slot and tight fitting pin approach.

In accordance with a third embodiment, optical bench 100 includes a support rail 114 and heat exchanger 4 farther includes at least one flat pad 116 disposed on the bottom of heat exchanger 4, wherein support rail 114 is disposed between optical bench 100 and heat exchanger 4. Flat pad 116 is preferably coated with a non-stick material, such as Teflon®, and is preferably disposed so as to be associated with support rail 114 when heat exchanger 4 is associated with optical bench 100. This advantageously allows heat exchanger 4 to slide smoothly and without sticking over support rail 114. In accordance with a third embodiment, an alternative to the flat pads 116 is the use of ball bearings sliding in a V-groove slot disposed in support rail 114. The heat exchanger 4 is preferably attached to the optical bench 100 via threaded bolts 120, which pass through support rails 114 and holds them against the optical bench 100. Belleville Disc Spring washers 122 are placed between the heat exchanger 4 and support rails 114 and the threaded bolts 120 are passed through the spring washers 122. These washers 122 slide back and forth over support rails 114 as heat exchanger 4 expands or contracts. Threaded bolts 120 preferably include sufficient flexibility so as to enable the expected length movement from the expansion and contraction of optical bench 100, heat exchanger 4 and/or laser head 2.

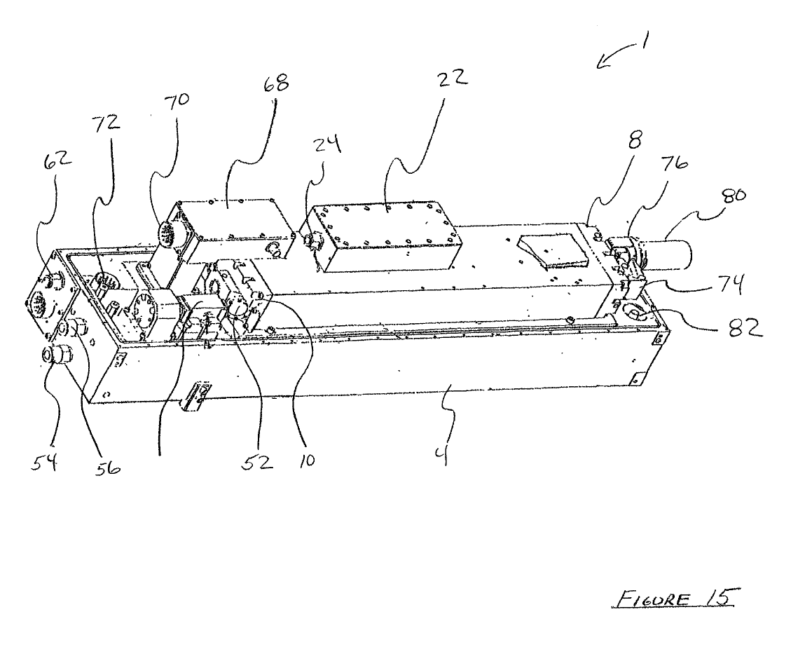

FIG. 14 isometrically illustrates a complete laser assembly 1 having a cover 124 and FIGS. 15 and 16 without cover 124. Laser head 2 and heat exchanger 4 are preferably contained on the top surface of optical bench 100. The BNC connector 126 shown is to monitor the signal coming out of an Automatic Down Delay Circuit (ADDC) assembly detector 68. BNC connector 126 preferably enables an operator to monitor the Q-switched laser pulse to check that the laser is functioning properly.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Accordingly, it is to be understood that the present invention has been described by way of illustrations and not limitation.

What is claimed is:

1. A thermally efficient laser head comprising:
a laser housing;
a heat exchanger disposed so as to be associated with said laser housing, wherein the combination of said laser housing and said heat exchanger includes a structurally neutral axis and a thermal force centroid axis, wherein said centroid axis and said neutral axis are disposed within different planes; and
a thermal tuning element, wherein said thermal tuning element is disposed relative to said heat exchanger and said laser housing so as to cause said centroid axis and said neutral axis to be disposed within coincidental planes.

2. The thermally efficient laser head according to claim 1, wherein said thermal tuning element is an insulating insert disposed so as to separate said heat exchanger and said laser housing.

3. The thermally efficient laser head according to claim 2, wherein said insulating insert includes an insulation thickness, wherein said insulation thickness is responsive to a predetermined amount of insulation.

4. The thermally efficient laser head according to claim 2, wherein said insulating insert includes an insulation area, wherein said insulation area is responsive to a predetermined amount of insulation.

5. The thermally efficient laser head according to claim 2, wherein said insulating insert is constructed of Teflon®.

6. The thermally efficient laser head according to claim 1, wherein said laser housing includes a housing coolant channel and wherein said heat exchanger includes an exchanger coolant channel, wherein said housing coolant channel is communicated with said exchanger coolant channel.

7. The thermally efficient laser head according to claim 6, wherein said thermal tuning element is an insulating insert disposed so as to separate said housing coolant channel and said heat exchanger.

8. The thermally efficient laser head according to claim 1, wherein said thermal tuning element is disposed so as to alter the thermal isotherm pattern of said laser head so as to cause said centroid axis and said neutral axis to be disposed within the same plane.

9. The thermally efficient laser head according to claim 1, wherein said thermal tuning element is a tuning slot, wherein said tuning slot includes an optimum geometry, wherein when said tuning slot has said optimum geometry, said centroid axis and said neutral axis are disposed so as to be aligned within the same plane.

10. The thermally efficient laser head according to claim 9, wherein said optimum geometry is determined experimentally.

11. The thermally efficient laser head according to claim 9, wherein said optimum geometry is determined mathematically.

12. The thermally efficient laser head according to claim 9, wherein said tuning slot is created via selective removal of material from said heat exchanger.

13. The thermally efficient laser head according to claim 9, wherein said tuning slot is created via selective removal of material from said laser housing.

14. A laser assembly comprising:
a laser head having a longitudinal axis, wherein said laser head includes a laser housing and a heat exchanger, wherein said laser housing is thermally associated with said heat exchanger; and
a support structure, wherein said support structure is unbendingly associated with said laser assembly so as to allow said laser head to expand along said longitudinal axis.

15. The laser assembly according to claim 14, wherein said support structure is an optical bench.

16. The laser assembly according to claim 14, wherein said support structure includes a bench slot and said heat exchanger includes a short slot, wherein said heat exchanger is disposed so as to communicate said short slot with said bench slot.

17. The laser assembly according to claim 16, wherein said laser assembly further includes a fitted pin disposed so as to be communicated with said bench slot via said short slot.

18. The laser assembly according to claim 14, wherein said support structure includes a mounting slot and said heat exchanger includes a fastening slot, wherein said heat exchanger is disposed so as to communicate said mounting slot with said fastening slot.

19. The laser assembly according to claim 17, wherein said laser assembly further includes a fastening pin disposed so as to be fasteningly communicated with said mounting slot via said fastening slot.

20. The laser assembly according to claim 14, wherein said laser assembly further includes a support rail disposed so as to be associated with said support bench and a spring washer disposed so as to separate said heat exchanger and said support rail.

21. The laser assembly according to claim 20, wherein said spring washer is slidingly associated with said support rail.

22. A laser assembly having a thermally neutral laser head comprising:
a structural neutral axis; and
a thermally induced force centroid axis, wherein said thermally neutral laser head is designed such that said thermally induced force centroid axis is coincidental with said structural neutral axis.

23. The laser assembly according to claim 22, further comprising an insulating insert disposed so as to cause said thermally induced force centroid axis to be coincidental with said structural neutral axis.

24. The laser assembly according to claim 22, further comprising a tuning slot, wherein said tuning slot is sized and shaped so as to cause said thermally induced force centroid axis to be coincidental with said structural neutral axis.

25. A laser assembly having a thermally neutral laser head comprising:
a structural neutral axis having a thermal profile; and
a thermally induced force centroid axis, wherein said thermal profile is tuned such that said thermally induced force centroid axis is coincidental with said structural neutral axis.

26. The laser assembly according to claim 25, wherein said thermal profile is tuned using an insulating insert.

27. The laser assembly according to claim 25, wherein said thermal profile is tuned via a tuning slot, wherein said tuning slot is sized and shaped so as to cause said thermally induced force centroid axis to be coincidental with said structural neutral axis.

28. The laser assembly according to claim 25, wherein said thermal profile is tuned by removing material from said thermally neutral laser head.

29. A laser assembly comprising:
a support bench; and
a laser head having a longitudinal axis, wherein said laser head is expandingly associated with said support bench so as to allow said laser head to expand and contract along said longitudinal axis.
